(19) United States
(12) Patent Application Publication
(10) Pub. No.: US 2004/0105563 A1
(43) Pub. Date: Jun. 3, 2004

(54) Method for the production of a hearing aid support and auxiliary part

(76) Inventor: Lourens George Bordewijk, Den Haag (NL)

Correspondence Address: Young & Thompson, Second Floor, 745 South 23rd Street, Arlington, VA, 22202, US

(21) Appl. No.: 10/468,213

(22) PCT Filed: Feb. 15, 2002
(86) PCT No.: PCT/NL02/00100

(30) Foreign Application Priority Data
Feb. 16, 2001 (NL) 1017384
Nov. 25, 2001 (NL) 1019429
Jan. 10, 2002 (NL) 1019726

(51) Int. Cl. H04R 25/00

(52) U.S. Cl. 381/328

(57) ABSTRACT

Method for the production of a hearing aid support matched to the auditory meatus of a user. With this method a setting material is introduced into the auditory meatus of the user. After said material has set, a negative is made and after machining this negative, if necessary, and placing the hearing aid, or a substitute for the hearing aid, therein, the support is produced. According to the invention an aid that corresponds to the shape of the universal hearing aid is introduced into the auditory meatus before setting material is introduced into the auditory meatus.

The present invention relates to a method for the production of a hearing aid support matched to the auditory meatus of a user, comprising introducing a setting material into the auditory meatus, which material is deformable in the set state, removing said part of set material from the auditory meatus, producing a negative of said part of set material by applying further setting material around it and setting said further material and removing said part of set material from said negative, fitting the universal hearing aid or a part of corresponding shape in the negative and introducing setting material into the gap between said hearing aid or part of corresponding shape and the remainder of the space in the negative, followed by removal from the negative of the support produced in this way.

A method of this type is generally known in the art. An impression of the auditory meatus is needed in order to be able to work with universal hearing aids. In this context a distinction must be made between hearing aids which are worn close to the end of the auditory meatus and hearing aids which are worn deep within the auditory meatus of the user. The invention relates to hearing aids that can be worn deep within the auditory meatus. With such hearing aids it is essential to provide an all-round seal with respect to the auditory meatus. Finally, it is necessary that the hearing aid/support combination is such that it does not generate any irritation to the user when introduced deep within the auditory meatus and, moreover, all-round sealing with respect to the auditory meatus can still be guaranteed.

In the art setting material is introduced into the auditory meatus and after it has set a negative is produced. This negative has a cavity that corresponds to the dimensions of the auditory meatus. If necessary, this cavity is further machined to some extent and the hearing aid or a part having the shape that corresponds to the hearing aid is always introduced therein. A plastic that sets is then introduced into the negative. After setting, the hearing aid support is thus obtained.

Although it has been found that by this means it is possible to make efficient use of universal hearing aids, problems arise with regard to the fit. If the hearing aid to be inserted is larger than the auditory canal, deformation will occur when the hearing aid is introduced into the canal. Apart from irritation and pressure, this deformation leads to an unpredictable deformation of the wall of the auditory meatus, as a result of which leakage of sound past the hearing aid can arise.

The aim of the present invention is to avoid these disadvantages and to provide improved abutment of the hearing aid support with the auditory meatus.

This aim is realised with a method as described above in that before the setting material is introduced into the auditory meatus an auxiliary part having a shape that corresponds to said universal hearing aid is placed in said auditory meatus.

On insertion of the relatively rigid hearing aid with the hearing aid support deformation of the auditory meatus takes place. This is more pronounced in the case of the relatively large dimensions of hearing aids that are present deep within the auditory meatus. As such, this deformation gives rise to possible irritation or other discomfort for the user. However, such discomfort is temporary. Because, according to the present invention, the deformation which subsequently will arise when inserting the hearing aid already takes place when inserting the aid, the setting material that is applied around the hearing aid will be optimally positioned. That is to say, sound leakages which were possible in the state of the art as a result of unpredictable changes in the shape of the auditory canal as a result of the deformation can no longer arise. After all, such unpredictable changes in the shape of the auditory canal will also take place when the auxiliary part is introduced and by introducing the setting material after introducing the auxiliary part full account will be taken of such changes in shape.

By, according to the invention, using the setting material in combination with the “dummy” for the hearing aid that has already been fitted, when making a casting of the auditory meatus immediate account is taken of the deformation of the auditory meatus as a consequence of the subsequent introduction of the relatively rigid hearing aid. After all, the aid or the dummy has a shape that corresponds to that of the hearing aid finally to be inserted or of at least a portion thereof or of the sleeve that is fitted around the hearing aid. Surprisingly, it has been found that it is not necessary to produce the auxiliary part from an absolutely rigid material. Adequate compensation for possible deformation is obtained if this auxiliary part is made from the same material as the setting material that is introduced into the auditory meatus (but, of course, after setting).

According to an advantageous embodiment, the setting material that is introduced into the auditory meatus is preferably the same as and/or adheres well to the material of the auxiliary part. As a result, further machining can subsequently take place easily when producing the negative.

According to an advantageous embodiment of the invention it is possible under all circumstances to ensure that material is present on either side of the auxiliary part by making a passageway in said auxiliary part. When the setting material is introduced, this moves through the auxiliary part via the passageway and emerges at the other side, that is to say the eardrum side. In the case of a hearing aid fitted deep within the auditory meatus, the distance from the eardrum is relatively small. Preferably this distance is approximately 5-8 mm. Preferably a protection for the eardrum will have to be fitted beforehand. This comprises, in particular, a cotton wool wad or the like that is introduced before the aid. A thread or the like can optionally be attached to the cotton wool wad in order thus to be able to remove the cotton wool wad from the ear again.

According to a further advantageous embodiment a protection comprising a part made of particularly soft silicone material is used instead of a cotton wool wad. This part is preferably made such that it tapers somewhat towards the eardrum, so that it is easily able to adapt to the shape of the auditory canal close to the eardrum. This part is preferably also elliptical in order to adapt in an optimum manner to the shape of the auditory meatus. Deformation can be improved by constructing such a protection made of particularly deforming material at least as a hollow cylinder. In order to facilitate insertion, a venting tube is preferably present. In view of the number of different shapes of auditory canals that are encountered, in practice use will be made of protections of various sizes, for example six different variants.

According to a further advantageous embodiment of the invention the auxiliary part is provided with a return channel. In this way it can be ensured that all material that moves into the auxiliary part via the passageway fills the spaces concerned without gas inclusions, that is to say the spaces concerned are completely filled. Optical monitoring can optionally be carried out with the aid of optical fibres which are fitted through or alongside the auxiliary part.

Surprisingly it has been found that particularly comfortable sealing of the auditory meatus is obtained in this way, with, furthermore, no leakage of sound taking place. This applies even in the case of hearing aids that are much broader than the width of the auditory meatus concerned. Auditory meati can be “forced” without any problem in this way.

The invention also relates to the auxiliary part described above to be fitted in the auditory meatus of a user for the production of a support for a hearing aid, comprising an elongated part of plastic material provided with a passageway extending through said auxiliary part in the longitudinal direction, which auxiliary part is bent in the longitudinal direction thereof with an angle of curvature (α) of at least 15°.

The invention will be explained in more detail below with reference to illustrative embodiments shown in the drawing.

In the drawing:

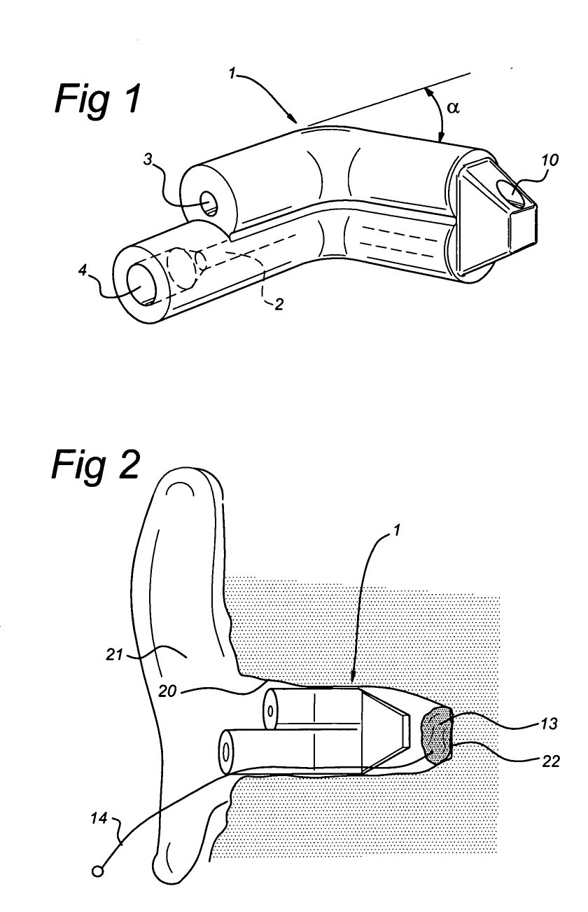

FIG. 1 shows, diagrammatically, a perspective view of the auxiliary part according to the invention;

FIG. 2 shows the insertion of the aid in the auditory canal of the user;

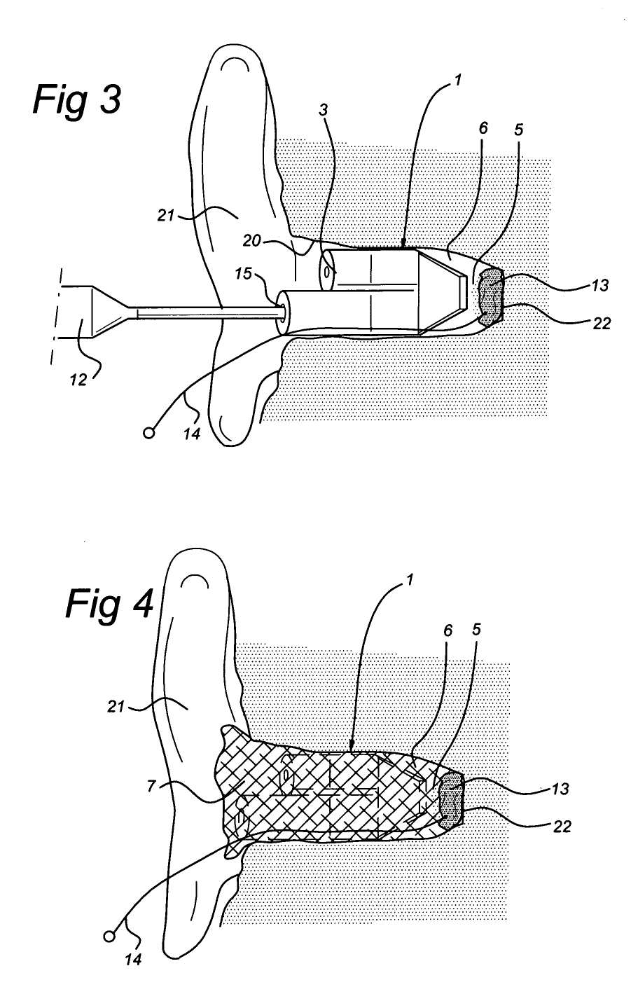

FIG. 3 shows the introduction of setting material into the auditory meatus of the user;

FIG. 4 shows the product obtained after setting;

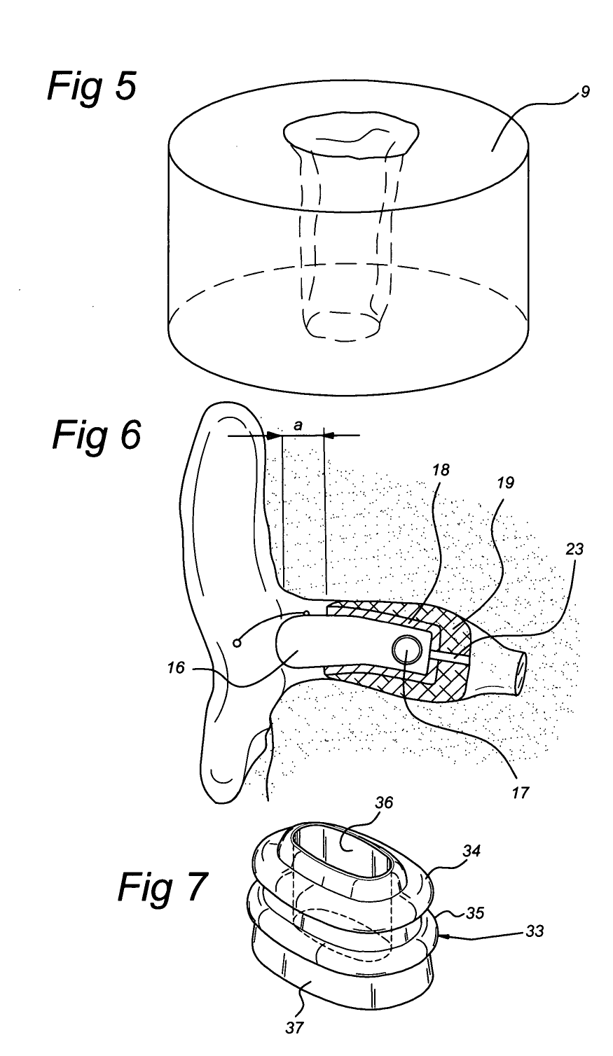

FIG. 5 shows the product according to FIG. 4 after processing, surrounded by a negative;

FIG. 6 shows the combination of hearing aid and hearing aid support obtained according to the invention; and

FIG. 7 is a variant of the cotton wool wad shown in FIGS. 2-4.

In FIG. 1 the auxiliary part according to the present invention is shown by 1. It consists of a part made of silicone material in which a passageway 2 has been made as well as a return channel 3. An introduction opening is indicated by 4 and an outlet opening 10 is located opposite this. The auxiliary part 1 is somewhat bent, which is indicated by angle α. In the variant shown this angle is approximately 45°. However, in the case of hearing aids fitted deep within the auditory meatus it is also possible to use an angle of, for example, approximately 15°. It has been found that when hearing aids with an angle of both 15 and 45° are used, in principle all auditory meati can be provided with a well-fitting hearing aid.

The shape of auxiliary part 1 corresponds to the shape of the hearing aid ultimately to be fitted and more particularly to the exterior shape of the sleeve or casing that is placed over such a hearing aid.

According to the present invention such an auxiliary part 1 is positioned deep within the auditory meatus of the user. Deep is to say that the front of aid 1 is approximately 5-8 mm away from the eardrum of the user. This is shown in more detail in FIG. 2. In this figure the auditory meatus is indicated by 20 and the user's auricle by 21. The eardrum has reference numeral 22. It can be seen from FIG. 2 that a plug of cotton wool material 13 is introduced before auxiliary part 1. A thread 14 is attached to this plug. By pulling on thread 14 it is possible to remove the plug of cotton wool material from the auditory meatus 20 in a simple and guaranteed manner under all conditions.

After inserting the auxiliary part 1 in the manner shown in FIG. 2, setting material is introduced with the aid of a syringe 12 (FIG. 3). This is effected by placing the tip 15 of the syringe in the introduction opening 4 in the auxiliary part 1. Settable material is then moved through the passageway 2 into the space in front of the auxiliary part 1. An indication that this space has been completely filled is obtained in that settable material flows out of the return channel 3. Settable material is introduced until the state shown in FIG. 4 is obtained. In this state material 5 is in front of the auxiliary part, material 6 around the auxiliary part and material 7 behind the auxiliary part, that is to say close to the auricle. After setting, the part shown in this way is removed and, after machining if necessary, a negative 9 having a cavity is produced, which is shown in FIG. 5. The production of a support for a hearing aid is continued in the conventional manner and finally the device obtained in FIG. 6 is obtained. The actual hearing aid, that is to say the component in which the electronics, possible switches, links for connecting to a PC or the like are located, is shown by 16 in FIG. 6. The battery of the hearing aid is indicated by 17, whilst 18 indicates a sleeve to be pushed onto the electronic component. The plug produced according to the invention is shown by 19. 23 is the sound passage.

It must be understood that the hearing aid shown in FIG. 6 is only an example. The present invention can be successfully used with a wide variety of other types of hearing aids which are known in the art and are designed to be used deep within the ear. It has been found that component 19 provides optimum comfort in wear and guarantees complete sealing for sound under all conditions.

The length a of component 19 is preferably less than 5 mm and in particular approximately 3 mm.

A variant of component 13 is shown in FIG. 7. This protection for the eardrum is indicated in its entirety by 33. It consists of a tapering component that is provided with peripheral ribs 34, 35 and is provided with a cavity 36 inside. This component is preferably made of a very soft silicone material such as, for example, the material Foto sil obtainable from Eggert Duitland. This component has been made oval to fit in the auditory meatus. At the location of an eardrum the dimensions of the principal axes of the protection shown here are approximately 8 mm and 5 mm. Because appreciable variations exist, a number of different sizes must be used despite the fact that the material of protection 33 is very flexible, for example six different sizes which increase/decrease in steps of half a millimetre. The end of protection 35 shown at the bottom of FIG. 7 is closed off and provided with a venting tube 37 so that air is able to escape when the protection is introduced into the auditory meatus.

After setting material has been introduced this will also adhere to the protection 33. This can be completely or partially separated from the other part that surrounds the auditory meatus by cutting or in some other way.

Although the invention has been described above with reference to a preferred embodiment, it will be understood that numerous modifications can be made which will be immediately obvious to those skilled in the art after reading the above description and fall within the scope of the appended claims.

1. Method for the production of a hearing aid support matched to the auditory meatus of a user, comprising introducing a setting material into the auditory meatus, which material is deformable in the set state, removing said part of set material from the auditory meatus, producing a negative of said part of set material by applying further setting material around it and setting said further material and removing said part of set material from said negative, fitting the universal hearing aid or a part of corresponding shape in the negative and introducing setting material into the gap between said hearing aid or part of corresponding shape and the remainder of the space in the negative, followed by removal from the negative of the support produced in this way, characterised in that before the setting material is introduced into the auditory meatus, an auxiliary part having a shape that corresponds to said universal hearing aid is placed in said auditory meatus.

2. Method according to claim 1, wherein said aid is provided with a passageway and said setting material is moved through said auxiliary part.

3. Method according to claim 2, wherein said auxiliary part is provided with a return channel through which air is removed from said space in front of said aid.

4. Method according to one of the preceding claims, wherein a protection for the user's eardrum is introduced before said auxiliary part is introduced.

5. Method according to claim 4, wherein said protection comprises a plug of cotton wool material.

6. Method according to claim 4, wherein said protection comprises a pre-shaped component of soft silicone material.

7. Method according to one of the preceding claims, wherein a sleeve component having an interior shape for accommodating said universal hearing aid is introduced into said negative.

8. Method according to one of the preceding claims, wherein there is a distance of at most 5 mm between the user's eardrum and said auxiliary part when introducing said setting material.

9. Method according to one of the preceding claims, wherein said auxiliary part is made of the same material as said setting material.

10. auxiliary part (1) to be fitted in the auditory meatus of a user for the production of a support for a hearing aid, comprising an elongated component of plastic material provided with a passageway (2) extending through said auxiliary part in the longitudinal direction, which auxiliary part is bent in the longitudinal direction thereof with a bend angle (α) of at least 15°.

11. Aid according to claim 10, wherein said auxiliary part is provided with a return channel (3).

12. Aid according to claim 10 or 11, wherein the inlet (4) of the feed channel is constructed to accommodate a metering device (12).

13. Auxiliary part according to one of claims 10-12, wherein said aid is made of a silicone material.
